(19) United States
(12) Patent Application Publication
(10) Pub. No.: US 2010/0058992 A1
(43) Pub. Date: Mar. 11, 2010

(54) APPARATUS FOR FEEDING AQUATIC ORGANISM

(75) Inventors: Hiroshi Miyake, Yokosuka-shi (JP); Tetsuya Miwa, Yokosuka-shi (JP); Mitsugu Kitada, Fujisawa-shi (JP); Kazuhisa Hori, Fujisawa-shi (JP)

Correspondence Address: SUGHRUE MION, PLLC, 2100 PENNSYLVANIA AVENUE, N.W., SUITE 800, WASHINGTON, DC, 20037, US

(73) Assignees: JAPAN AGENCY FOR MARINE-EARTH SCIENCE AND TECHNOLOGY, Yokosuka-shi, Kanagawa (JP); ENOSHIAM PFI CO., LTD., Fujisawa, Kanagawa (JP)

(21) Appl. No.: 12/531,462

(22) PCT Filed: Mar. 14, 2008
(86) PCT No.: PCT/JP2008/054734

§ 371 Date: Nov. 23, 2009

(30) Foreign Application Priority Data
Mar. 16, 2007 (JP) 2007-068496

(51) Int. Cl. A01K 63/00; A01K 63/04

(52) U.S. Cl. 119/252; 119/259; 119/262

(57) ABSTRACT

A breeding apparatus comprises a main water tank 10 in which deep-sea organisms are housed along with seawater; a hot water supplying device 20; and a hot water discharging device 30. A hot water pipe 22 extends from a hot water tank 21 to the bottom of the main water tank 10, an end configuring a spouting hole 22a which emits hot water upwardly. The hot water discharging unit 30 is positioned above the spouting hole 22a and circulates the hot water ascended from the spouting hole 22a back to the warm water tank 23, which is outside of the main water tank 10, via a hot water discharging pipe 31. The hot water emitted from the spouting hole 22a forms a cold water zone 12 and a localized hot water zone 11, while the interface between this hot water zone 11 and the cold water zone 12 is formed in a rapidly ascending fashion in respect to the vertical cross section of the seawater in the main water tank 10.

### TECHNICAL FIELD

The present invention relates to a breeding apparatus for aquatic organisms suitable for breeding organisms living in a chemosynthetic ecosystem, particularly those among deep-sea organisms living in an environment such as a hydrothermal vent zone.

### BACKGROUND ART

Conventionally, as a breeding apparatus for aquatic organisms, particularly for deep-sea organisms, there has been such an apparatus which comprises a water tank constituted by a pressure container; a water current aspirator which produces an unidirectional (transverse direction) water current within the water tank; a temperature zone generating unit, such as a heater, which forms a localized temperature zone by heating or cooling a part of water current flowing at the bottom of the water tank; and a temperature zone retaining unit, such as a nozzle, which retains the localized temperature zone formed by the temperature zone generating unit by preventing the zone from diffusing throughout the water tank, the breeding apparatus being for breeding deep-sea organisms, such as shellfish, that would not drift with the water current within the temperature zone retaining unit (see Patent Literature 1).

Patent Literature 1: JP H 9-117235 A

Here, aquatic organisms in a hydrothermal vent zone and its vicinity are those that consume components dissolved in hydrothermal water and microorganisms using those components as energy source. There are various kinds of organisms and with respect to their habitat range, for example, there are organisms that prefer the vicinity of hydrothermal water; that prefer the interface between hydrothermal and cold waters; that prefer areas of a certain distance from hydrothermal water; and that live while moving across the interface.

In contrast, in the above-described conventional breeding apparatus for deep-sea organisms, since the deep-sea organisms are housed within the temperature retaining unit, thus limiting breedable organisms to a small minority of species. In addition, since the organisms are always exposed to the same localized temperature zone, which is a different environment from an actual habitat environment for those deep-sea organisms, there have been problems due to the difficulty to sustain those organisms over a prolonged period of time.

### DISCLOSURE OF THE INVENTION

The present invention was made in view of the above-described existing circumstances and its object is to provide a breeding apparatus which enables the formation of an environment comparable to an actual hydrothermal vent zone is capable of sustaining various kinds of aquatic organisms, particularly deep-sea organisms, over a prolonged period of time.

The breeding apparatus for aquatic organisms of the present invention is characterized in that the apparatus comprises a main water tank in which aquatic organisms are housed; a hot water supplying device which emits hot water upwardly from a spouting hole located at the bottom of the main water tank; and a hot water discharging device located in the upper part of the main water tank, which discharging device discharges ascended hot water to outside of the tank; and that said apparatus forms a cold water zone and a localized hot water zone in the tank water.

According to the breeding apparatus of the present invention, a steep temperature gradient can be formed in the horizontal direction, so that much the same environment surrounding an actual hydrothermal vent zone can be attained for various deep-sea organisms.

Further, organisms can choose a preferable habitat zone and various deep-sea organisms inhabiting in a hydrothermal vent zone can also be sustained over a prolonged period of time.

A preferable embodiment of the breeding apparatus for aquatic organisms of the present invention is characterized in that the hot water supplying device comprises a hot water tank in which water collected by the hot water discharging device is heated and a hot water pipe which extends from the hot water tank to the main water tank, an end of the hot water pipe configuring the spouting hole, and that the hot water supplying device constitutes a hot water circulation system together with the hot water discharging device.

The breeding apparatus of this embodiment enables effective generation and recycle of hot water.

Further, in another preferable embodiment, the breeding apparatus for aquatic organisms of the present invention is characterized in that the hot water supplying device comprises the hot water tank in which hot water is generated by heating supplied fresh water and the hot water pipe which extends from the hot water tank to the main water tank, an end of the hot water pipe configuring the spouting hole.

The breeding apparatus of this embodiment enables replenishment of fresh water as hot water, thus facilitating operation and maintenance of the water quality.

Further, in these preferable embodiments, the spouting hole at the end of the hot water pipe can be arranged inside an imitation stone dome which mimics a hydrothermal chimney structure such that the hole is at a position below the hot water emitting opening on top of the imitation stone dome by 150 mm or less.

By this constitution, the temperature of hot water in the vicinity of the hot water emitting opening can be increased, resulting in a greater growth density of the breeding organisms

Still another preferable embodiment of the breeding apparatus for aquatic organisms of the present invention is characterized in that the hot water tank of the hot water supplying device is arranged above the main water tank and that hot water introduced into the hot water pipe is emitted from the spouting hole by gravitational force.

According to the breeding apparatus of this embodiment, there would be no need for a pressure device such as a pump, thus attaining simplification of the device structure and maintenance and management thereof.

Further, yet another preferable embodiment of the breeding apparatus for aquatic organisms of the present invention is characterized in that hot water comprises prescribed concentrations of oxygen and carbon dioxide and contains hydrogen sulfide.

According to the breeding apparatus of this embodiment, hot water having components comparable to hot water being emitted in an actual seafloor hydrothermal vent zone can be attained, thus allowing a more favorable environment for deep-sea organisms.

Further, another preferable embodiment of the breeding apparatus for aquatic organisms of the present invention is characterized in that the apparatus comprises a cold water circulation device which filters cold water of the main water tank with the temperature of the water adjusted as the water is circulated back to the main water tank.

The breeding apparatus of this embodiment enables effective generation and recycle of the cold water. The hot water zone and cold water zone can be maintained within one main water tank in good condition.

A filter of the above-described cold water circulation device can be provided with a pipe for supplying fresh water to supply fresh water, thereby enabling more effective maintenance of the water quality of the cold water zone.

Further, another preferable embodiment of the breeding apparatus for aquatic organisms of the present invention is characterized in that the main water tank comprises a depression at the bottom of the cold water zone, which depression contains mud and organic matter.

According to the breeding apparatus of this embodiment, hydrogen sulfide, methane, and other hydrocarbons are generated, thereby enabling breeding of deep-sea organisms inhabiting in a cold seep zone. Deep-sea organisms of both hydrothermal vent zone and cold seep zone can be maintained within one main water tank.

Further, yet another preferable embodiment of the breeding apparatus for aquatic organisms of the present invention is also characterized in that the apparatus comprises a temperature sensor which measures the temperature of hot water; an oxygen sensor which measures the concentration of oxygen in hot water; a pH sensor which measures the hydrogen ion exponent; and a temperature sensor which measures the temperature of cold water;

and that, based on the values measured by each respective sensor, the apparatus further comprises a control unit which regulates a heater, aeration with nitrogen, addition of carbon dioxide, and a radiator such that the temperature of hot water, concentration of oxygen in hot water, pH of hot water, and temperature of cold water are within prescribed ranges.

According to the breeding apparatus of this embodiment, the breeding environment can be maintained automatically.

Another breeding apparatus for aquatic organisms of the present invention is characterized in that; the apparatus comprises the main water tank in which aquatic organisms living in a chemosynthetic ecosystem are housed along with water, the hot water supplying device which emits hot water upwardly from the spouting hole arranged at the bottom of the main water tank, and the hot water discharging device arranged in the upper part of the main water tank, which discharging device discharges ascended hot water to outside of the tank;

that a localized hot water zone having a steep temperature gradient against cold water zone in the tank water is formed; and

that the above-described hot water supplying device comprises an addition unit for energy source required by the above-described organisms of a chemosynthetic ecosystem, such as carbon dioxide and hydrogen sulfide.

This breeding apparatus allows inclusion of desired amounts of carbon dioxide and hydrogen sulfide in hot water, thus is advantageous in breeding organisms living in a chemosynthetic ecosystem.

### BRIEF DESCRIPTION OF THE DRAWINGS

FIG. 1 is a cross-sectional diagram illustrating a closed-circulating-type apparatus as one embodiment of the breeding apparatus for deep-sea organisms according to the present invention.

FIG. 2 is a cross-sectional diagram illustrating, as another embodiment of the breeding apparatus for deep-sea organisms according to the present invention, an apparatus in which fresh seawater can be provided as hot water.

FIG. 3 is a cross-sectional diagram illustrating, as yet another embodiment of the breeding apparatus for deep-sea organisms according to the present invention, an apparatus in which fresh seawater can be provided to the cold-water circulation system.

### BEST MODE FOR CARRYING OUT THE INVENTION

Hereinafter, the breeding apparatus for aquatic organisms according to the present invention will be explained in more detail by way of embodiments with reference to the figures illustrating the breeding apparatus for deep-sea organisms as an example.

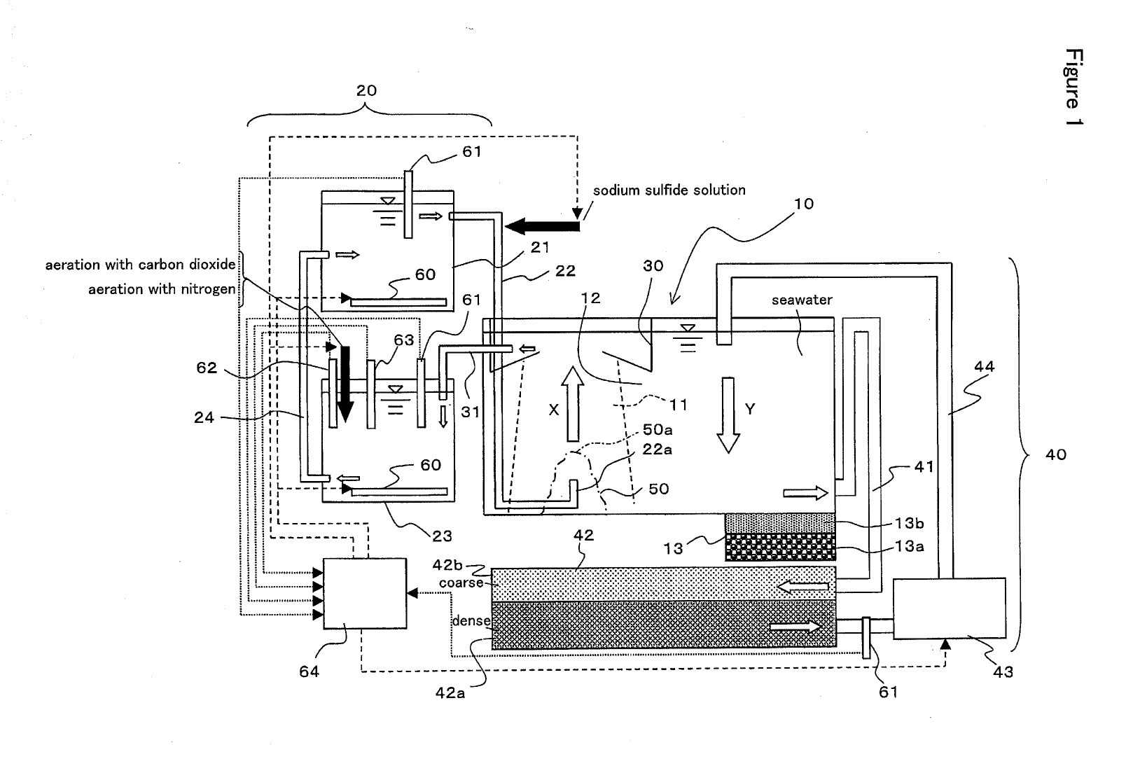

FIG. 1 is a cross-sectional diagram illustrating the first embodiment of the breeding apparatus for deep-sea organisms according to the present invention.

In the same figure, this breeding apparatus comprises a main water tank 10 in which deep-sea organisms (not shown) are housed along with seawater, the seawater being one example of breeding water; a hot water supplying device 20; and a hot water discharging device 30.

In the present embodiment, the hot water supplying device 20 comprises a hot water tank 21 and a warm water tank 23, which tanks 21 and 23 are equipped with a hot water pipe 22 supplying hot water and a warm water pipe 24 supplying warm water, respectively.

The hot water pipe 22 extends from the hot water tank 21 to the bottom of the main water tank 10, an end configuring a spouting hole 22a which emits hot water upwardly. In addition, in the present embodiment, the spouting hole 22a is camouflaged with an imitation stone dome 50 to constitute a hot water chimney.

Meanwhile, the warm water pipe 24 is connected to the hot water tank 21 arranged above the warm water tank 23, the pipe being configured so that it can supply warm water to the hot water tank 21.

Further, the hot water discharging device 30 is arranged above the spouting hole 22a from which hot water is emitted, and circulates the hot water ascended from the spouting hole 22a back to the warm water tank 23 arranged outside of the main water tank 10 through a hot water discharging pipe 31.

In this manner, in the present embodiment, the hot water supplying device 20 constitutes a circulation system of hot water, being comprised of the hot water tank 21; the hot water pipe 22 and the spouting hole 22a; the hot water discharging device 30 and the hot water discharging pipe 31; and the warm water tank 23 and the warm water pipe 24, so that hot water is effectively generated and recycled.

Additionally, the hot water emitted from the spouting hole 22a forms a cold water zone 12 and a localized hot water zone 11, while the interface between this hot water zone 11 and the cold water zone 12 is formed in a rapidly ascending fashion in respect to the vertical cross section of the seawater in the main water tank 10 (see the dashed line regions in FIG. 1).

The temperature of the hot water is usually 30-100° C., and typically around 60° C. The temperature of the cold water zone 12 is usually 1-7° C., and typically about 4° C.

Such localized hot water zone 11 allows a steep temperature gradient to form in the horizontal direction in the seawater of the main water tank 10, so that much the same environment surrounding an actual hydrothermal vent zone is attained for various deep-sea organisms.

Accordingly, deep-sea organisms can choose a preferable habitat zone and various deep-sea organisms inhabiting around a hydrothermal vent zone can be sustained over a prolonged period of time.

Hereinafter, the above-described circulation system of hot water will be explained.

The hot water emitted from the spouting hole 22a is comparable to hot water emitted from an actual hydrothermal vent zone in a deep-sea environment, the hot water, the pH being set at lower than that of the seawater in the main water tank by addition of concentrated carbon dioxide under a low dissolved oxygen environment, comprising hydrogen sulfide.

That is, hydrothermal water in the deep-sea environment is seawater percolated down to below the seafloor and heated by magma, which seawater then dissolved the surrounding minerals of the earth and was emitted from a hydrothermal vent; therefore, such hydrothermal water contains significant amounts of hydrogen sulfide and carbon dioxide in an oxygen-depleted environment, thus exhibiting weak acidity. Hence, the above-described hydrogen sulfide-containing hot water of a low oxygen level, a high carbon dioxide level, and a low pH, is comparable to hydrothermal water around a hydrothermal vent zone in the deep-sea.

In the present embodiment, the hot water, due to gravitational action, passes through the hot water pipe 22 which extends from the hot water tank 21 arranged above the main water tank 10, and is cooled by coming into contact with the cold water zone 12 as the hot water emerges upwardly from the spouting hole 22a (see the arrow X in the figure), which then trapped by the hot water discharging device 30. Consequently, the hot water zone 11 is such that it does not diffuse (expand) in the horizontal direction within the main water tank 10.

Next, the seawater (the hot water which has been cooled) trapped by the hot water discharging device 30 is transferred to the warm water tank 23 through the hot water discharging pipe 31 and heated by a heater 60 as necessary, while being aerated with nitrogen (specifically, nitrogen having a low oxygen level) and carbon dioxide. Accordingly, the circulated seawater is imparted with the desired temperature (typically, 20-30° C.), a low oxygen level, and a high carbon dioxide level.

Such a low oxygen environment is useful in attaining stable presence of hydrogen sulfide which is readily oxidized, as well as in creating a habitat environment for organisms in a chemosynthetic ecosystem, especially for anaerobic chemosynthetic bacteria, while addition of carbon dioxide is useful in providing organisms with a carbon source and forming a low pH environment.

In this case, the oxygen concentration is typically, but is not particularly limited to, 0-1 mg/L. Further, the concentration of carbon dioxide is also not particularly limited, however, it is typically preferable that the aeration with carbon dioxide be controlled such that it is discontinued when a low pH of 6.8 is attained relative to pH 8.2 of normal seawater and restarted when the pH exceed 6.8.

The temperature and concentrations of oxygen and carbon dioxide of the seawater in the warm water tank 23 are measured by water temperature sensor 61, oxygen sensor 62, and pH sensor 63, respectively, and the measured data are transmitted to control unit 64.

The control unit 64 in turn transmits control signals, based on the measured data, to the heater 60, nitrogen aeration device, and carbon dioxide aeration device (the devices are not shown in the figure) to regulate turning on/off of those equipments, by so doing achieving the above-described desired water temperature and concentrations of oxygen and carbon dioxide.

Then, the seawater is sent pressurized to the hot water tank 21 via the warm water pipe 24, and if needed, is heated typically to 60-100° C. while being added with sodium sulfide, which is an example of precursor of hydrogen sulfide. The added amount of sodium sulfide is appropriately changeable and for example, 500 g/20 L of sodium sulfide solution may be added approximately 10 ml every 10 minutes.

This addition of sodium sulfide enables preparation of hot water comparable to that in a deep-sea hydrothermal vent zone, the hot water comprising the desired temperature, concentrations of oxygen and carbon dioxide, and hydrocarbon content.

Also in the hot water tank 21, as in the case of the warm water tank 23, the measured water temperature data by the water temperature sensor 61 are transmitted to the control unit 64 to be used in preparation and control of the desired hot water.

Subsequently, the hot water comparable to that in a deep-sea hydrothermal vent zone is sent through the hot water pipe 22 to the spouting hole 22a, where the water is emitted into the main water tank 10.

Here, the spouting hole 22a of the hot water pipe 22 is arranged within the imitate stone dome 50 which, as described above, mimics a hydrothermal chimney; however, a greater distance between the spouting hole and hot water emitting opening 50a which is formed in the vicinity of the top of the imitation stone dome 50 would cool the hot water from the hot water tank 21, which may result in no emission of the desired hot water.

Therefore, it is preferred that the distance between the spouting hole 22a and the hot water emitting opening 50a be not more than approximately 150 mm. This can minimize the heated region in the upper part of the dome 50, so that the temperature of hot water near the hot water emitting opening 50a is maintained at high temperature, allowing visual confirmation of shimmer by the hot water and a denser growth of the breeding organisms.

Further, from the view point of preventing the temperature of hot water flowing through the hot water pipe 22 from decreasing, it is preferred that the thermal insulation properties of aforementioned pipe 22 be improved and also that the pipe be installed such that the pipe has a minimum length. Additionally, usage of transparent material enables the presence or absence of clogging of the pipe to be visually confirmed, thereby facilitating the maintenance.

The above-described imitation stone dome 50 does not always have to be provided, and for example, the spouting hole 22a may be provided among arranged stones, and in some cases, the spouting hole 22a may be left exposed at the bottom of the water tank.

As described above, the breeding apparatus of the present embodiment can locally provide hot water to the main water tank, not with direct addition of carbon dioxide and hydrogen sulfide to the breeding water tank (the main water tank), but with inclusion of them in the hot water during the generation of hot water.

Therefore, since the breeding apparatus of the present embodiment provides hot water components comparable to those in an actual hydrothermal vent zone and the formed hot water zone is localized and does not readily diffuse, it is not only extremely effective for breeding deep-sea organisms, but also can reduce corrosion of the main water tank without putting excessive burden thereon.

In reference to FIG. 1, the breeding apparatus of the present embodiment comprises cold water circulation device 40.

This cold water circulation device 40 contains a cold water discharging pipe 41 connected at the bottom of the cold water zone 12, a filter 42 arranged below the main water tank 10, a radiator 43, and a cold water supplying pipe 44 connected to the upper part of the cold water zone 12.

Additionally, provided at the bottom of the cold water zone 12 is a depression 13, where an organic layer 13a and mud layer 13b are deposited in layers.

This cold water circulation device 40 is to attain a water zone which mimics a cold seep zone in a deep-sea environment, that is, a water zone where cold water is seeping out near oceanic plate.

In an actual cold seep zone, methane and hydrogen sulfides generated from decomposition of organic matter are provided in an anoxic mud layer.

In the present embodiment, by forming the organic layer 13a of the above-described depression 13 using, for example, dog food, and depositing thereon the mud layer 13b which is made of mud having normal reducing properties and mud collected from deep ocean, it is possible that a formula feed such as dog food is decomposed in an oxygen-depleted condition to spontaneously generate methane, hydrogen sulfide, and ammonia.

In a chemosynthetic ecosystem of cold seep, methane and hydrogen sulfide present in the mud are considered as energy source. The breeding apparatus of the present embodiment provides an environment mimicking that of a cold seep, thus as described above, methane, hydrogen sulfide, and ammonia are spontaneously generated, assuming the roles as energy source, carbon source, and nitrogen source. Therefore, the breeding apparatus of the present embodiment is not only capable of simply keeping organisms in a chemosynthetic ecosystem of cold seep alive in a conventional way, but it also allows the organisms to breed and propagate.

Hereinafter, circulation of the cold water according to the cold water circulation device 40 will be explained. First, the cold water entered the cold water discharging pipe 41 from the vicinity of the depression 13 is filtered as it passes through, in a sequential order, the filter 42, a coarse layer 42b, and a dense layer 42a. This physically filters the suspension, and further nitrification by microorganisms detoxicates the ammonia excessively generated by biometabolism and decomposition of organic matter in the mud.

Then, the filtered cold water is measured for the temperature by the water temperature sensor 61 and sent to the radiator 43 where the water is chilled as necessary. As described above, the water temperature sensor 61 can transmit/receive data to/from the control unit 64, which can regulate the operation of the radiator 43.

In general, the temperature of cold seep water is approximately 1-4° C.

Subsequently, the seawater chilled by the radiator 43 flows through the cold water supplying pipe 44 and is supplied from the upper part of the cold water zone 12 down to the lower part (see arrow Y in the figure).

As explained above, the breeding apparatus for deep-sea organisms according to the present embodiment comprises both hydrothermal vent zone and cold seep zone, and further, the apparatus can realistically reproduce the deep-sea environment with the localized hot water zone 11 having a cross section of a rapidly ascending fashion and adjacent cold water zone 12, thereby enabling breeding of various deep-sea organisms.

Breedable deep-sea organisms include, but are not limited to, deep-sea organisms inhabiting generally at the depth of 200 meters or greater and organisms inhabiting around a hydrothermal vent or cold seep zone, and specifically, Bythograeidae, Shinkaia crosnieri (hydrothermal vent galatheid crabs), Galatheidae, Hippolytidae, Thoracica (hydrothermal vent barnacles), Lamellibrachiidae (Satsuma tubeworms), Bathymodiolinae, Vesicomyidae (deep-sea cold-seep clams), Siboglinidae, Mytilidae, organisms on a whale bone, Porcellanidae (Anomuran crabs), Zoarcidae.

Additionally, worm species of Alvinellidae (Paralvinella) inhabiting in a hyperthermal zone around a hydrothermal vent and hydrothermal microorganisms such as thermophilic bacteria can also be cultured.

As an example, when the above-described breeding apparatus of the present invention was used to breed Vesicomyidae (deep-sea cold-seep clams), a new record of breeding period for 53 days was established compared to 7 days of breeding period by a conventional breeding apparatus.

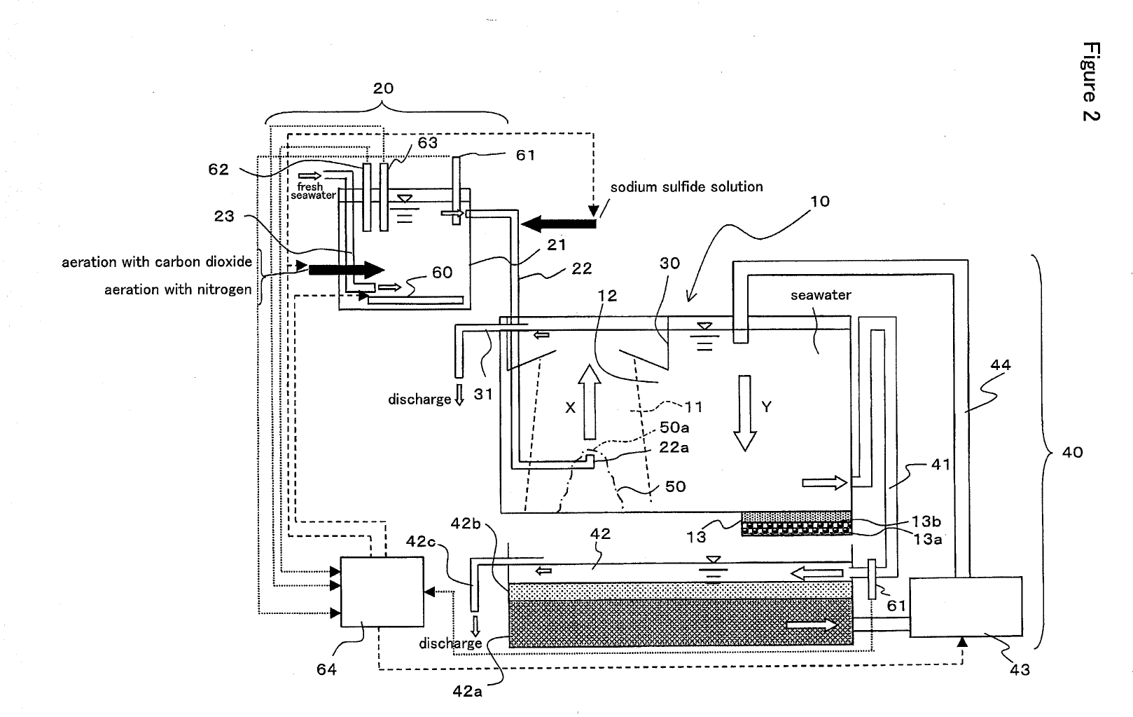

FIG. 2 is a cross-sectional diagram illustrating the second embodiment of the breeding apparatus for deep-sea organisms according to the present invention, and explanation thereof is abbreviated herein by applying the same referencing numbers for those parts which are in common with the first embodiment illustrated in FIG. 1.

In the breeding apparatus according to the first embodiment illustrated in FIG. 1, although the apparatus comprises both hot water and cold water circulation systems, it is preferable to change water periodically from the view point of operation and maintenance of the water quality. In such a case, there is a possibility that a direct input of fresh seawater into the main water tank 10 may raise the water temperature of the cold water zone 12 as the temperature of the fresh seawater is relatively high.

Therefore, in the second embodiment, continuous replenishment of fresh seawater has been achieved by supplying fresh seawater to the hot water tank 21 where the water is heated to the prescribed temperature, and then by emitting from the sprouting hole 22a of the hot water pipe 22.

That is, the breeding apparatus of this embodiment, as in the above-described first embodiment of the breeding apparatus, comprises the main water tank 10; the hot water supplying device 20; the hot water discharging device 30; and the cold water circulation device 40; however, hot water emitted from the spouting hole 22a overflows from the hot water trap of the hot water discharging device 30 and is discharged directly from the hot water discharging pipe 31 without being circulated back to the warm water tank 23 (see FIG. 1)

The hot water tank 21 of the hot water supplying device 20 comprises, along with seawater pipe 23, the water temperature sensor 61, oxygen sensor 62, and pH sensor 63. The fresh seawater supplied via the seawater pipe 23 is heated by the heater 60 within the hot water tank 21 and also aerated with carbon dioxide and nitrogen as necessary, and after being adjusted to the desired temperature and concentrations of oxygen and nitrogen, the fresh seawater is emitted from the spouting hole 22a via the hot water pipe 22.

Here, the hot water pipe 22 is installed such that its length is shortened as much as possible within the water tank, and its spouting hole 22a is arranged inside the imitation stone dome 50 opening at approximately 100 mm below from the hot water emitting opening 50a of the imitation stone dome 50, so that the increased temperature of hot water is maintained.

Meanwhile, with regard to the cold water circulation device 40, the cold water discharging pipe 42c is arranged on top of the water tank of the filter 42 which is provided in the cold water circulation pathway of the cold water discharging pipe 41, such that excess water is drained from this cold water discharging pipe 42c.

According to the breeding apparatus of this embodiment, not only the water quality is maintained by constant water exchange while suppressing a temperature increase in the cold water zone 12, but also a constant water level of the main water tank 10 can be maintained as the fresh seawater replenished as hot water overflows from the hot water discharging device 30 and the filter 42, and is drained from the discharging pipes 31 and 42c, respectively. In addition, since the warm water tank is not necessarily operated, an increase in the temperature and/or humidity inside the water tank room can be suppressed.

Further, by positioning the spouting hole 22a for the hot water closer to the hot water emitting opening 50a of the imitation stone done 50, the amount of heat from the emitting opening 50a was increased, so that shimmer in the seawater caused by temperature difference could be visually confirmed. Additionally, the breeding organisms started to grow more densely around the top of the dome 50 where the temperature is high and behave as if being in a deep-sea hydrothermally active zone.

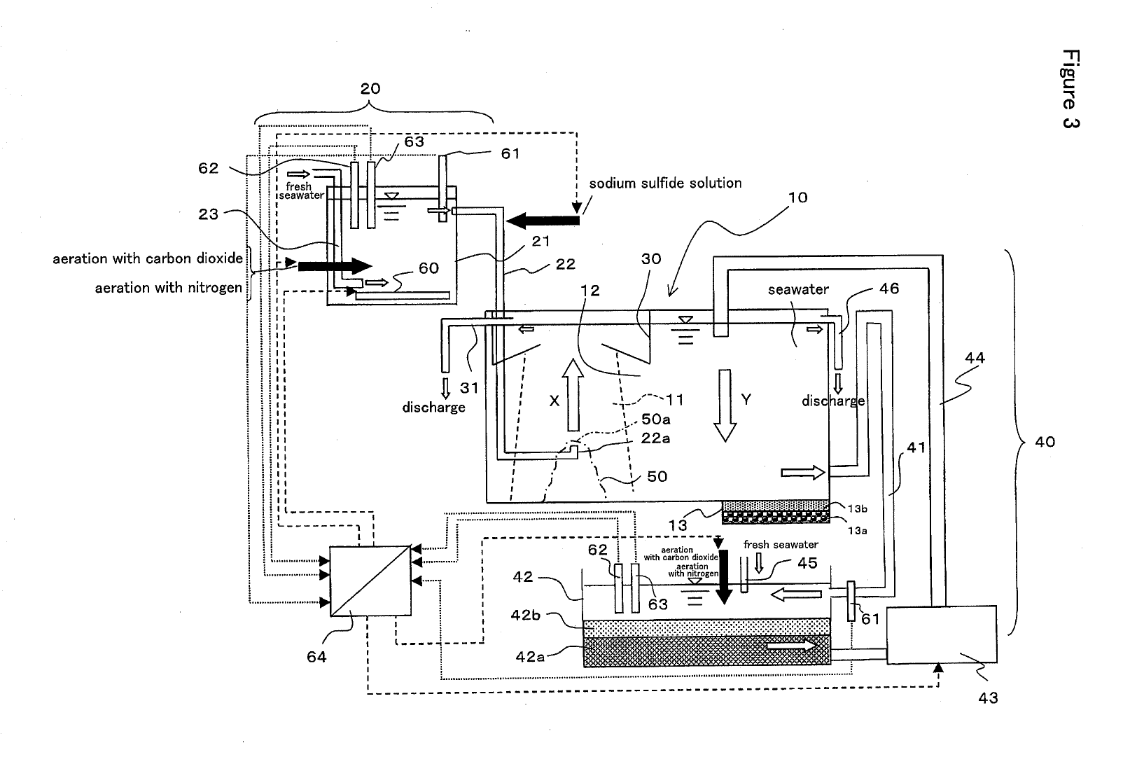

FIG. 3 is a cross-sectional diagram illustrating the third embodiment of the breeding apparatus for deep-sea organisms according to the present invention. In this apparatus, maintenance of the water quality such as pH is facilitated by improving the efficiency of water exchange in such a way that fresh seawater is emitted from the spouting hole 22a as the hot water in the same manner as the second embodiment illustrated in FIG. 2, and at the same time, that fresh seawater is also supplied to the filter 42 of the cold water circulation device 40.

That is, the breeding apparatus of this embodiment comprises the main water tank 10; the hot water supplying device 20; the hot water discharging device 30; and the cold water circulation device 40; and with regard to the main water tank 10, the hot water supplying device 20 and the hot water discharging device 30, explanation thereof is abbreviated herein as there is no fundamental difference from the second embodiment.

In the present embodiment, the cold water circulation device 40 comprises, as aforementioned embodiments, the cold water discharging pipe 41, the filter 42, the radiator 43, and the cold water supplying pipe 44.

Here, the filter 42 comprises, along with the oxygen sensor 62 and the pH sensor 63, seawater pipe 45 for water exchange for cold water circulation, the seawater pipe 45 through which fresh seawater is replenished into the filter 42.

The cold water entered the filter 42 from the cold water discharging pipe 41 is combined with fresh seawater, which then aerated with carbon dioxide and/or nitrogen in response to the above-described sensors 62 and 63 to be adjusted to the desired water quality and filtered through the filtration layers 42a and 42b, followed by adjustment to the desired temperature by the radiator 43, and the resulting cold water is supplied to the cold water zone 12 in the main water tank 10 via the cold water supplying pipe 44.

As described above, in this embodiment, while fresh seawater is supplied as the hot water, the fresh seawater is supplied to the cold water circulation system as well, thus requiring sensing and water quality maintenance of the two systems for the hot water side and cold water side by the control unit 64.

According to the breeding apparatus of the third embodiment, efficiency of water exchange can be improved as described above, thus facilitating the maintenance of water quality. Particularly, sodium sulfide added as energy source reacts with water and is dissolved in the low-temperature breeding water tank as hydrogen sulfide, and as the reaction proceeds, it reacts with dissolved oxygen in the seawater and become oxidized to sulfate ions, which in turn react with metal oxides, hydroxides, and carbonates which are present in the seawater, and becomes suspended as sulfates, hence deteriorating the water quality. Adopting such an embodiment permits suppression on generation of undesired substances of sulfate and an excessive increase in concentration of hydrogen sulfide.

The breeding apparatus according to the present invention, for example the breeding apparatus of each of the above-described embodiments, can be applicable for not only the deep-sea organisms, but also for various species of aquatic organisms regardless of the species being from freshwater, estuarine, or marine, and particularly useful in breeding organisms inhabiting in a chemosynthetic ecosystem.

The term “organisms inhabiting in a chemosynthetic ecosystem”, as used herein, refers to organisms that live in an environment in which volcanic activities and active fault line(s) have been activated due to the crustal activities of a planet or satellite, such as a hydrothermal vent zone which is hydrogen sulfide-rich such as a deep-sea hot spring or a cold seep zone which is methane-rich from leaching, which organisms constitute an ecosystem in which chemosynthetic microorganisms that utilize those chemical materials are the producers of the food chain, having evolved independently.

Hereinbefore, the present invention has been described in detail with preferable embodiments; however, the present invention is not limited by such embodiments and thus various modifications can be made within the scope of the outline of the present invention. For example, the form of the main water tank and details of each device/unit can be modified appropriately. Specifically, in all of the above-described embodiments, the hot water tank 21 is arranged above the main water tank 10 such that the hot water is emitted according to siphonage principle; however, the hot water may be pressure-fed using a pump(s) depending on the size of the room in which the present breeding apparatus is placed. In addition, the relative density of hot water is less than that of cold water, thus in theory, the hot water would ascend without providing forcible spouting force.

Further, in the above-described second and third embodiments, fresh seawater alone is provided as the hot water; however, for example, it is also possible to supply the warm water tank 23 of the first embodiment with fresh seawater such that a part of the circulating hot water can sequentially be replaced with fresh seawater.

Using a model for the spouting hole 22a would attain an environment closer to an actual environment and make the apparatus more interesting as an exhibit. Further, microorganisms can be grown by placing a whale bone in the main water tank 10, and by so doing, an environment closer to a deep-sea chemosynthetic ecosystem can be attained.

Additionally, for the materials for the water tanks and pipes, though not particularly limited to the followings, materials having anti-corrosive nature for hydrogen sulfide are preferable and various resins and ceramics, stainless and titanium alloys can be utilized.

### INDUSTRIAL APPLICABILITY

According to the present invention, a breeding apparatus for aquatic organisms in which an environment comparable to an actual hydrothermal vent zone may be formed, the breeding apparatus being capable of breeding various aquatic organisms, particularly deep-sea organisms, over a prolonged period of time, can be provided.

1. A breeding apparatus for aquatic organisms, characterized in that said apparatus comprises a main water tank in which said aquatic organisms are housed along with water; a hot water supplying device which emits hot water upwardly from a spouting hole arranged at the bottom of said main water tank; and a hot water discharging device arranged in an upper part of said main water tank, which unit discharges ascended hot water out of said main water tank; and that said apparatus forms a cold water zone and a localized hot water zone in said water.

2. The breeding apparatus for aquatic organisms according to claim 1, characterized in that a steep temperature gradient is formed between said hot water zone and said cold water zone.

3. The breeding apparatus for aquatic organisms according to claim 1, characterized in that said water is seawater.

4. The breeding apparatus for aquatic organisms according to claim 1, characterized in that said hot water supplying device comprises a hot water tank in which water collected by said hot water discharging device is heated to produce hot water and a hot water pipe which extends from said hot water tank to said main water tank, an end of said pipe configuring said spouting hole, and that said hot water supplying device, together with said hot water discharging device, constitutes a hot water circulation system.

5. The breeding apparatus for aquatic organisms according to claim 1, characterized in that said hot water supplying device comprises a hot water tank in which supplied fresh water is heated to produce hot water and a hot water pipe which extends from said hot water tank to said main water tank, an end of said pipe configuring said spouting hole.

6. The breeding apparatus for aquatic organisms according to claim 4, characterized in that said spouting hole of said hot water pipe is arranged inside an imitation stone dome mimicking a hydrothermal chimney such that said hole is opened at a position below said hot water emitting opening on top of said imitation stone dome by 150 mm or less.

7. The breeding apparatus for aquatic organisms according to claim 4, characterized in that said hot water tank of said hot water supplying device is arranged above said main water tank such that hot water introduced into said hot water pipe is emitted from said spouting hole by gravitational force.

8. The breeding apparatus for aquatic organisms according to claim 1, characterized in that said hot water has prescribed concentrations of oxygen and carbon dioxide and contains hydrogen sulfide.

9. The breeding apparatus for aquatic organisms according to claim 1, characterized in that said apparatus comprises a cold water circulation device which filters cold water of said main water tank as said cold water is circulated back to said main water tank with temperature adjusted.

10. The breeding apparatus for aquatic organisms according to claim 9, characterized in that a filter of said cold water circulation device is provided with a pipe for replenishing fresh water.

11. The breeding apparatus for aquatic organisms according to claim 1, characterized in that said main water tank comprises a depression at the bottom of said cold water zone, said depression containing mud and organic matter therein.

12. The breeding apparatus for aquatic organisms according to claim 8, characterized in that said apparatus comprises a temperature sensor which measures the temperature of said hot water; an oxygen sensor which measures the concentration of oxygen in said hot water; a pH sensor which measures the hydrogen ion exponent; and a temperature sensor which measures the temperature of said cold water;
and that, based on the values measured by each respective sensor,
said apparatus further comprises a control unit which regulates a heater, aeration with nitrogen, addition of carbon dioxide, and a radiator such that the temperature of said hot water, concentration of oxygen in said hot water, pH of said hot water, and temperature of said cold water are within prescribed ranges.

13. A breeding apparatus for aquatic organisms, characterized in that:
said apparatus comprises a main water tank in which aquatic organisms of a chemosynthetic ecosystem are housed along with water; a hot water supplying device which emits hot water upwardly from a spouting hole arranged at the bottom of said main water tank; and a hot water discharging device arranged in the upper part of said main water tank, which unit discharges ascended hot water out of said main water tank;
said apparatus forms a cold water zone and a localized hot water zone having a steep temperature gradient; and said hot water supplying device comprises an addition unit for energy source required by organisms of a chemosynthetic ecosystem, such as carbon dioxide and hydrogen sulfide.

14. The breeding apparatus for aquatic organisms according to claim 2, characterized in that said water is seawater.

15. The breeding apparatus for aquatic organisms according to claim 2, characterized in that said hot water supplying device comprises a hot water tank in which water collected by said hot water discharging device is heated to produce hot water and a hot water pipe which extends from said hot water tank to said main water tank, an end of said pipe configuring said spouting hole, and that said hot water supplying device, together with said hot water discharging device, constitutes a hot water circulation system.

16. The breeding apparatus for aquatic organisms according to claim 3, characterized in that said hot water supplying device comprises a hot water tank in which water collected by said hot water discharging device is heated to produce hot water and a hot water pipe which extends from said hot water tank to said main water tank, an end of said pipe configuring said spouting hole, and that said hot water supplying device, together with said hot water discharging device, constitutes a hot water circulation system.

17. The breeding apparatus for aquatic organisms according to claim 14, characterized in that said hot water supplying device comprises a hot water tank in which water collected by said hot water discharging device is heated to produce hot water and a hot water pipe which extends from said hot water tank to said main water tank, an end of said pipe configuring said spouting hole, and that said hot water supplying device, together with said hot water discharging device, constitutes a hot water circulation system.

18. The breeding apparatus for aquatic organisms according to claim 2, characterized in that said hot water supplying device comprises a hot water tank in which supplied fresh water is heated to produce hot water and a hot water pipe which extends from said hot water tank to said main water tank, an end of said pipe configuring said spouting hole.

19. The breeding apparatus for aquatic organisms according to claim 3, characterized in that said hot water supplying device comprises a hot water tank in which supplied fresh water is heated to produce hot water and a hot water pipe which extends from said hot water tank to said main water tank, an end of said pipe configuring said spouting hole.

20. The breeding apparatus for aquatic organisms according to claim 5, characterized in that said spouting hole of said hot water pipe is arranged inside an imitation stone dome mimicking a hydrothermal chimney such that said hole is opened at a position below said hot water emitting opening on top of said imitation stone dome by 150 mm or less.
